(19) United States
(12) Patent Application Publication
(10) Pub. No.: US 2020/0230901 A1
(43) Pub. Date: Jul. 23, 2020

(54) METHOD AND APPARATUS TO MANUFACTURE A RIGID POLYMER PANEL HAVING INTEGRALLY FORMED OPTICAL QUALITY SURFACES

(71) Applicant: 10x Technology LLC, Libertyville, IL (US)

(72) Inventor: Robert M. Pricone, Libertyville, IL (US)

(21) Appl. No.: 16/639,151

(22) PCT Filed: Aug. 14, 2018
(86) PCT No.: PCT/US18/46650

§ 371 Date: Feb. 14, 2020

Related U.S. Application Data
(60) Provisional application No. 62/545,242, filed on Aug. 14, 2017.

(51) Int. Cl. B29D 11/00

(52) U.S. Cl. CPC B29D 11/00269; B29K 2033/12; B29D 11/0048

(57) ABSTRACT

A continuous polymer sheet casting apparatus includes first and second endless belts positioned in face to face relationship to each other for a portion of their lengths to form between their inside surfaces a mold cavity for molding a polymeric sheet therebetween, and a container in fluid communication with the mold cavity, the container configured to introduce a liquid monomer or liquid polymer and curing agent and/or initiator to the cavity for polymerization therein; a controlled cooling apparatus in thermal communication with the mold cavity, configured to cool and solidify the polymeric sheet as it moves through the mold cavity, wherein either the first, the second, or the first and second endless belts include a microstructured optical quality tool area on at least a portion of said belt or belts. A mold and process for molding is also disclosed.

### CROSS-REFERENCE TO RELATED APPLICATIONS

This application claims the benefit of priority to PCT patent application no. PCT/US18/46650, filed on Aug. 14, 2018, which in turn claims priority to U.S. provisional application No. 62/545,242, filed on Aug. 14, 2017, which is hereby incorporated by reference.

### FIELD

This disclosure relates to a process and apparatus for forming and directly replicating polymerics products with precise detail, and more particularly, to a process and apparatus for making relatively rigid panel products of thermoplastic material having surfaces with precision microstructures.

### BACKGROUND

Processes and apparatus for embossing precision optical patterns such as microcubes, in a thin film resinous sheet or laminate, are described in U.S. Pat. Nos. 4,486,363; 4,478,769; 4,601,861; 5,213,872; 6,015,214, and more recently U.S. Pat. No. 6,908,295. Others have made versions of microcubes using a complicated multi-layer version of casting resin onto a moving drum, such as taught in U.S. Pat. No. 3,935,359. All of these patents are incorporated herein by reference. In the production of synthetic resin optical sheeting film, highly precise embossing processes (generally exceeding the capabilities of the current micromolding processing techniques for synthetic resins), is required because the geometric accuracy of the optical elements determines its optical performance. However, besides precision optical retro-reflective sheeting, various other applications have been developed that would be highly enhanced by the formation of highly precise shapes and structures in resinous relatively rigid sheets or panels that are thicker than normally can be embossed.

In the manufacture of road signs, embossed cube-corner thin film on the order of 0.006″ (150-microns) is normally adhered to an underlying metal or other rigid substrate, such as plywood, so that the laminated panel has enough structural integrity to be mounted as a road sign. Other applications include solar panels in which an array of Fresnel type lenses are continuously formed in a thin film and then laminated to a rigid transparent polymer substrate, and in which the composite is about 3 mm thick. Such applications require the embossing of thin thermoplastic material film to provide the precisely formed and spaced functional geometric elements, or arrays of such functional geometric elements on the film surface. In the case of solar panels, not only must the lens element be optically accurate to focus light on the target area for energy conversion, but the spacing of the lens elements relative to each other also is of importance to achieve the necessary efficiency of light directed to the receiving energy converting junction.

These geometric elements, or precision microstructures, are defined by any or all of the following characteristics: precise depths; flat surfaces with precise angular orientation; fine surface smoothness; sharp angular features with a very small radius of curvature; and precise dimensions of the elements and/or precise separation of the elements, within the plane of the film. The precise nature of the formed surface affects the functional attributes of the formed products, whether used for microcubes or other optical features such as the radial Fresnel lenses in solar panels; or as light directing or diffusing panels for lighting fixtures; or as channels for microfluidics, or in fuel cells; or for accurate dimensions, flatness and spacing when providing a surface for holding nanoblocks in Fluidic Self Assembly (FSA) techniques; or for imparting a microtextured surface that is not optically smooth within an array that includes, or excludes additional microarchitecture. For example, in the solar industry, optical film having Fresnel type lens surfaces may be achieved by continuously embossing rolls of polymer film having a thickness of about 0.5 mm and then laminating the film to a thicker substrate, forming a panel of about 3 mm thick. This can also be accomplished by molding the panels. Both processes are time consuming and expensive.

Applicant's method and apparatus for embossing microstructured surfaces onto thicker rigid panels using a “double belt” press was disclosed in PCT/US2013/031918 (WO2013169381), which is incorporated herein by reference. While that method and the double belt press work for this purpose, the cost of the equipment and the ancillary material handling equipment for placing an unembossed panel on a tool, feeding that tool and panel to the machine, removing the embossed panel and tool and then stripping the panel from the tool, is very expensive, requires large spacing, and is thus prohibitive for most installations.

In the lighting industry, plastic lens panels for troffers have been formed by injection molding, or by continuous cast embossing. In those instances, the lenses so formed do not have the requisite optical quality to accurately direct light. And if done with film and laminating, the cost becomes prohibitive for commercial purposes to form a rigid substrate. With the advent of LED lighting, the optical accuracy of the lens is even more critical to direct the light and to prevent glare from the LEDs. Prior art extruder embossers have been used to directly provide some formed surfaces on the extruded polymer. But the method and apparatus for doing this does not allow for very accurate surfaces to be formed, as the tools for forming the surfaces on the extruded polymer have inadequate means of applying the necessary pressure to the extruded polymer at the forming location, and also lack adequate methods for promptly cooling the forming tool to “freeze” the formed surfaces into the requisite accurate shape.

Thin film structures having optical quality surfaces and apparatus are known. For example, in prior art such as U.S. Pat. No. 4,486,363, there is shown a method for continuously embossing a precision optical pattern requiring sharp angles and flatness of faces in certain detail, on one surface of a continuous flexible polymer. The method is performed with the aid of a generally cylindrical endless metal embossing belt with an outer surface having a precision optical embossing pattern, which is the reverse of the precision optical pattern to be formed on one surface of the flexible polymer. But as noted, this method was restricted to thin polymer films, flexible enough to bend around rollers and then wound up as a roll. Gauges greater than 1 mm (0.0040″) could not be processed by this method.

### SUMMARY

A continuous casting apparatus for polymeric sheet includes first and second endless belts, positioned in face to face relationship to each other for at least a portion of their lengths, forming between their inside surfaces a mold cavity for molding the polymeric sheet therebetween. A container is also included and is in fluid communication with the mold cavity. The container is configured to introduce a liquid monomer and curing agent or liquid polymer to the mold cavity. A controlled cooling apparatus in thermal communication with the mold cavity is also included. It is configured to cool and solidify the polymeric sheet as it moves through the mold cavity. The first, the second, or the first and second endless belts include a microstructured optical quality tool area on at least a portion of the belt or belts.

A polymer casting apparatus for forming a relatively rigid polymer panel has a microstructured optical quality tool area on at least a portion of one side of said panel. The apparatus includes: two molding members positioned in face to face relationship to each other defining a mold cavity therebetween; means for introducing a liquid monomer or polymer into said mold cavity; and means for controlling cooling and solidifying said polymer in said mold cavity. At least one of the mold members is configured to have a tool area defining a microstructured surface which during the process of making is filled by the liquid monomer or polymer, and when solidified the panel produced thereby has a microstructured optical quality surface that is a mirror image of said tool area.

A process for making a relatively rigid polymeric panel having a microstructured surface on at least one area on said panel includes the steps of: casting a liquid monomeric or polymeric feed into a mold cavity, the cavity being defined by two continuously moving members; passing a microstructured tool area on at least a portion of one of said members and polymerizing and solidifying the monomeric or polymeric feed as it is moved through said mold cavity by converting the monomeric or polymeric feed to a solid polymer and withdrawing said solid polymer from said mold cavity whereby at least one surface of said polymer will have a microstructured optical quality feature formed thereon.

A molding process for making a relatively rigid molded polymeric panel having a microstructured surface on at least one area on said panel includes the steps of: introducing a liquid monomer and curing agent or liquid polymer to a mold cavity formed between a first mold member and second mold member; pressing the first mold member into the second mold member, at least one of the first and second mold members comprising a microstructured tool area; cooling and solidifying the polymer or polymerizing and solidifying the monomer in the mold cavity to form the molded polymeric panel and cooling the molded polymeric panel; and removing the molded panel from the mold, wherein the panel has the microstructured surface formed thereon.

A more complete understanding of the present invention and other objects, aspects, aims and advantages thereof will be gained from a consideration of the following description of particular embodiments read in conjunction with the accompanying drawings provided herein. In an embodiment, the novelty of this process and apparatus to overcome the aforementioned deficiencies of the prior art continuous film embossers, is achieved by significantly modifying the smooth tool arrangement of conventional continuous cast acrylic by forming microstructured patterns in the co-monomers while forming a relatively rigid sheet.

### BRIEF DESCRIPTION OF THE DRAWINGS

FIG. 1 is a schematic layout of a typical prior art continuous caster as found in the industry for producing thicker sheets of acrylic.

FIG. 2 is a schematic layout of a typical continuous caster as modified in accord with the present invention to provide precision optical structures in relatively rigid sheet.

FIG. 3 is an overhead plan view a portion of a belt as modified in accordance with the present invention.

FIG. 4 is a plan view depicting in enlarged format one form of microcube structure as processed by the modified equipment.

FIG. 5 is a perspective view of a mold embodiment and a cooling bath for the mold.

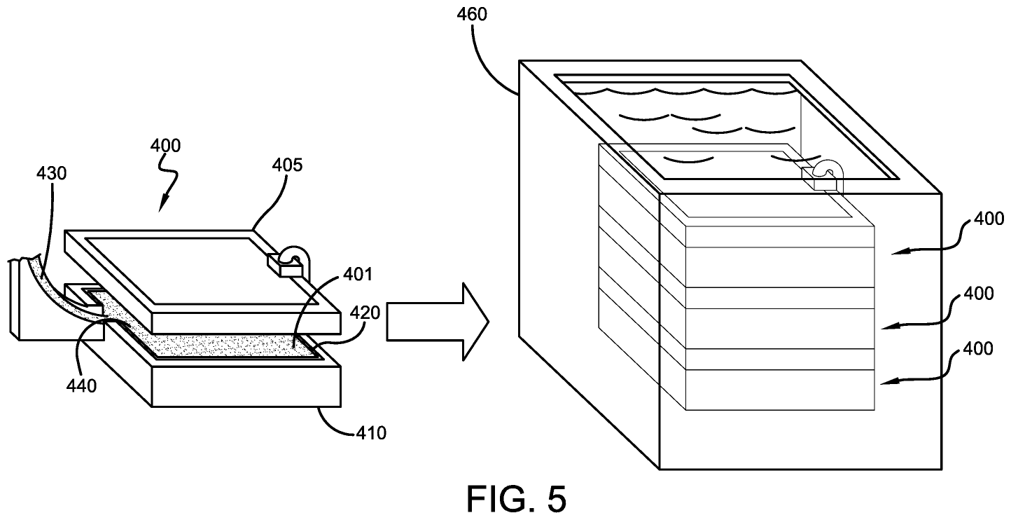

### DETAILED DESCRIPTION

Presented herein is a method and apparatus to continuously cast acrylate monomers and polymers in situ with a continuous metal mold that replaces at least in part the smooth metal belt typically used during the manufacture of continuous cast acrylic sheet and thereby directly replicates a microstructured precision optical pattern to form a relatively rigid sheet or panel having optical quality surfaces on one face of the sheet or panel.

For purposes hereof, a relatively rigid sheet panel is a panel that, while it may have some degree of flexibility, it is sufficiently self-supporting to be considered as a structural unit without any additional material laminated or adhered to it to render it functional for mounting. Cast PMMA is sufficiently rigid for such applications with a shear modulus of 1.70 GPa. Other materials useful for the relatively rigid panel may, for example, have a shear modulus of 0.5 to 5 GPA, such as for example, 0.8 to 2.5, or 1 to 2 GPa. Shear modulus may be determined by ISO 537. This does not preclude additional layers being adhered to the formed panel as part of a mounted structure, or to form a more complex multilayer object, but it is the intent that the current manufacturing steps of adhering the thin formed film to a thicker substrate to provide structural integrity by lamination, or otherwise, will have been eliminated. Also in considering the phrase relatively rigid or rigid herein the panel stiffness may depend both on the thickness and elasticity modulus of the material to be processed and wherein the thickness or rigidity is so stiff it would not permit continuous roll to roll embossing from the extruded material.

As used in the present application, “precision microstructured” material generally refers to a resinous polymeric material having a precise geometric pattern of very small elements or shapes, such as 0.5 mm to 100 nm, 0.1 mm to 1 micrometer, or 0.05 to 10 micrometers in at least one dimension, and in which the precision of the formation contributes to the functionality of the product. In an embodiment, the precision of the panel is a function of both the precise geometry of the product, the capability of the forming tool, and the process and apparatus to conserve the geometric integrity from tool to article formed in the panel (on one or both sides thereof), and may require one or more of the following characteristics (not all products necessarily requiring all of them):

(a) flat surfaces with angular slopes controlled to a tolerance of 5 minutes relative to a reference value, more preferably a tolerance of 2 minutes relative to a reference value; or to at least 99.9% of the specified value;

(b) having precisely formed (often, very smooth) surfaces with a roughness of less than 100 Angstroms rms relative to a reference surface, such as 75 to 5 Angstroms rms, or 60 to 25 rms, more preferably with a roughness configuration closely matching that of less than 50 Angstroms rms relative to a reference surface; or, if the surface requires small irregularities it may be greater than 100 Angstroms and less than 0.00004 inch (1 micron), such as 1000 Angstroms to 10 microns or 5 microns to 2000 Angstroms (surface roughness may be determined by ISO 10110-8);

(c) having angular acute features with an edge radius and/or corner radius of curvature of less than 0.001 inches (25 microns), such as 20 to 1 micron, or 15 to 5 microns, and controlled to less than 0.1% of deviation, such as 0.05 to 0.005%, or 0.01 to 0.0001% of deviation;

(d) with respect to individual features, one or more, or a majority of such features having a depth less than 0.040 inches (1000 microns), more preferably less than 0.010 inch (250 microns), such as 0.005 inches to 0.0001 inches;

(e) precisely controlled dimensions within the plane of the sheeting, in terms of the configuration of individual elements, and/or the location of multiple elements relative to each other or a reference point, in each case within +/−5, 10, or 15 μm; and/or

(f) characteristic length scale (depth, width, and height) less than 0.040 inch (one millimeter), such as less than 0.5 mm, or 0.4 to 0.001 mm, with an accuracy that is better than 0.1% of a discrete optical element, such as better than 0.05% or better than 0.01%.

In certain embodiments of precision microstructured panels, discrete elements and/or arrays of elements may be defined as formed recessed regions, or formed raised regions, or combinations of recessed and raised regions, relative to the unformed regions of the panel. In other embodiments, all or portions of the precision microstructured panel may be continuously formed with patterns of varying depths comprising elements with some of the characteristics described above. Typically, the discrete elements or arrays of elements are arranged in a repetitive pattern; but the product may also have non-repetitive arrays of precision microstructured shapes. Exemplary types of precision microstructured panels, and their characteristics of precision, include:
Retroreflective materials for road reflectors or signage, Fresnel lenses for optical solar array applications, and lenses for LED lighting; in each instance precise flatness, angles and uniform detail are important. Cube-corner type reflectors, to retain their functionality of reflecting light back generally to its source, require that the three reflective faces of the cube be maintained flat and within several minutes of 90° relative to each other, such as within 3 degrees, or 2 degrees of 90 degrees. Spreads beyond this, or unevenness in the faces, results in significant light spread and a drop in intensity at the location desired. Also, surface smoothness is required so light is not diffused.
Feature to feature accuracy for LCD display systems, LED lighting, and for solar panels in which adjacent formed recesses not only have to be precisely shaped, the spatial relations of the array of recesses also must be closely adhered to.
The ability to manufacture microstructures with an edge radius of less than 0.001 inches (25 microns), such as less than 20 microns, or 15 to 5 microns, and with very sharp points and sharp ridges (less than 0.00028 inches (7 microns), such as 1 to 6 microns, or 2 to 5 microns.
Volumetric accuracy for microfluidic and microwell applications with 90% or greater accuracy of the cross-sectional area being conserved through the length of channel; and from channel to channel, and/or well to well, in which dimensions range from 0.00020 to 0.008 inches (5-200 microns) depth, such as 10 to 150 microns, or 20 to 100 microns; and 0.00020 inches to 10 inches (5 microns to 25.4 cm) width or length, such as 15 microns to 15 cm, or 100 microns to 1 cm. The channels may have convoluted shapes and microtextured shapes.
Surface roughness for microfluidic applications that allow for low friction and minimal surface drag, all resulting in smooth continuous non-diffusive flow, allowing for laminar fluid flow.
The avoidance of residual stresses by providing essentially stress-free microstructures. This is important for some optical, FSA, and for microfluidic applications where the detection mechanisms use fluorescent polarization technology. Materials with stress generally have strand orientation, which acts like a polarizing lens. Materials that contain residual stresses may relax that stress during subsequent processing or during the life cycle of the product, resulting in dimensional instability.
For Fresnel lenses, either radial or lenticular.

The precision microstructured pattern typically is a predetermined geometric pattern that is replicated from the tool. It is for this reason that the tools of the preferred embodiment are produced from electroformed masters that permit the creation of precisely designed structures.

The method and apparatus disclosed herein to continuously cast MMA monomers and PMMA in situ with a continuous metal mold provides a microstructured precision optical pattern on the polymeric material to form a relatively rigid sheet or panel having optical quality surfaces on one face of the sheet or panel. (The terms “sheet” and “panel” are used interchangeably herein.)

In an embodiment, methyl-methacrylate (MMA) monomer used in the process may be copolymerized with certain other thermoplastic monomers, such as, for example, other acrylates. Other co-monomers may be used so long as the material can be imprinted with the features and the Tg is in an acceptable range, such as 100° C. to 150° C., 103 to 130° C., or 105° C. to 110° C. for the process.

Typically, the continuous cast process disclosed herein can produce sheet material from 3 mm to 5 mm thick and impart some structured features in the formed surface, but the structures are limited to decorative structures or other like designs. High precision optics require structures with angle accuracies of 2-3 arc minutes, surface roughness (calculated by Ra, which is an average of measured microscopic surface peaks and valleys using a profilometer) of <5 nm, such as less than 4 nm, or 1 to 3 nm and tip and valley sharpness (which is the radius saw-tooth feature measured in microns) of <2 μm, such as less than 1 micrometer or 1 nm to 0.5 micrometer. By installing a generally cylindrical flexible endless metal belt incorporating at least a section having a precision optical pattern, the reverse of which is formed on one surface of the sheet, this accuracy can be accomplished by transferring the pattern on the belt into the polymer which is then cured with the pattern permanently replicated in the juxtaposed surface of the sheet.

In an embodiment, the device disclosed herein includes the cylindrical endless metal forming belt installed on a conventional continuous cast PMMA production line. This improvement may be incorporated as additions to an otherwise typical continuous cast apparatus. As a further improvement, both top and bottom belts surrounding the top and bottom surface of the acrylate material can be patterned. There are optical advantages to having one optical pattern on the surface of a PMMA sheet and a second, different pattern on the opposite surface. One additional feature is that the cost of these modifications to current typical continuous cast machines is far less than building a new machine with all of these components.

In forming precise optical surfaces by embossing, it is difficult to achieve both adequate heat and pressure to effectively “force” the polymer down into the small cavities defining the optical quality microstructure surfaces. While this has been successfully accomplished in thin film, the complexity of the equipment for heating, pressing and cooling the film (or in some instances using an extruder to preheat the polymer film before introduction to the embossing tool) is a significant factor. Because of equipment restraints, the film (or polymer if extruded) must be kept below a certain flow temperature. In some circumstances, the cooling station will be maintained in the range of 35° F. to 41° F. (2° C. to 5° C.).

In an embodiment disclosed herein, by using the exothermic reaction caused by the mixing of the two monomers which polymerize to form the acrylate polymeric material, adequate flow to produce sheet also enables formation of the optical quality surfaces without the need for additional pressure, as the material “flows” into the microstructured surfaces of the forming tool. Air entrapment in the tool cavities is absorbed into the fluid polymer.

For purposes of this application and in the interest of brevity, continuous polymer casting machines (such as used by Aristech Surfaces and Mitsubishi Chemical) are simply referred to herein as “casters.”

As noted, the typical prior art continuous cast sheet forming processes will have means (not shown in detail) to cool the monomers between the belts as they react during the exothermic polymerization reaction. The exothermic reaction may require cooling to control the reaction rate. In an embodiment, the sheet forming conditions can remain the same; however, the primary difference is the replacement of the flat, polished stainless steel belt surfaces with engineered microstructures that will provide optical quality functional surfaces on the sheet, rather than the smooth surfaces that would normally be provided on products such as transparent Plexiglas.

By the method and apparatus disclosed herein, microstructured surfaces may be formed onto thicker polymeric materials to form relatively rigid sheets or panels up to about 5 mm thick, such as 1 mm to 4 mm, or 2 mm to 3 mm.

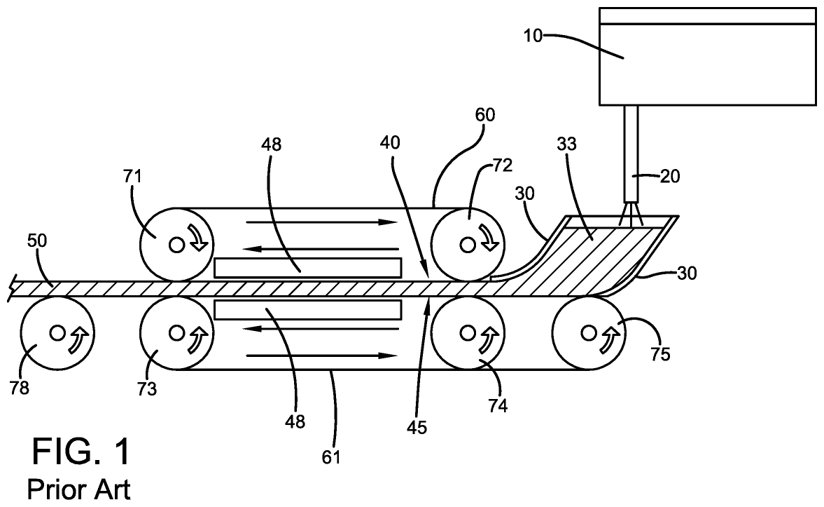

Referring now to the figures, FIG. 1 depicts a prior art caster for producing relatively thick polymeric sheets. It includes a tank 10 which supplies monomer via a tube 20 to a trough or reservoir 30 from which the flowable material 35 feeds into the apparatus with a top surface 40 and bottom surface 45. Belts 60 and 61 are driven by rollers 71-74 to push the flowable material between the belts 60, 61, and form the material into a cast strip 50. Because of the exothermic reaction of the monomer(s), in order to form a sheet with minimal internal stress, the monomer must be cooled on a controlled basis as it reacts until it solidifies into the cast strip 50. The case strip 50 is carried along away from the caster by an exit belt 76 driven by an exit roller 78. To this end, a controlled cooling arrangement 48 is provided in the commercial casters. The belts 60, 65 may be made of smooth stainless steel.

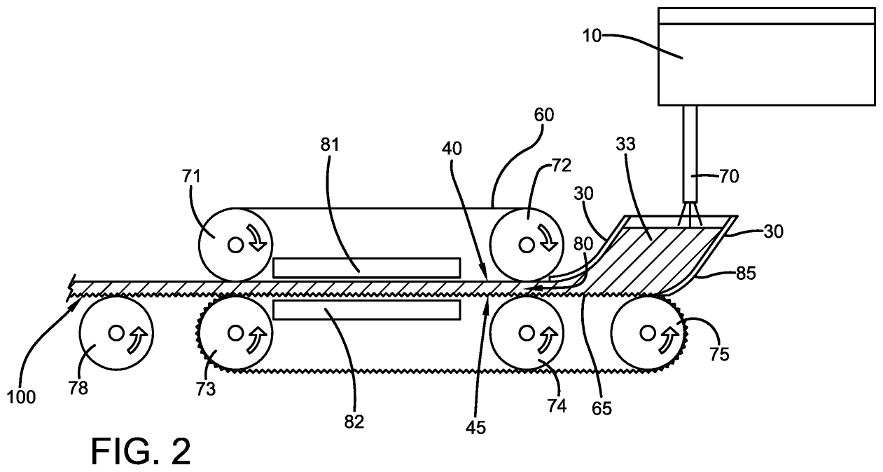

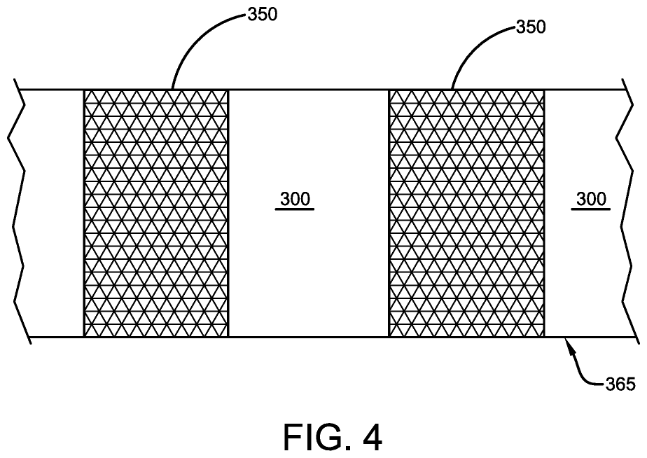

FIG. 2 is a diagrammatic view of an embodiment of an apparatus that could employ the stainless steel belts such as 60 and 61 of FIG. 1, but in this case, a belt 61 is replaced by a microstructured belt 65 which has microstructured surfaces formed therein. These belts 60, 65 may also be considered mold members that are continuously moving. The mold member with a microstructured surface 65 is represented by jagged lines in the Figures as representations only. In an embodiment, either the first 61, the second 65, or the first and second endless belts 61, 65 include a microstructured optical quality tool area 350 (FIG. 4) on at least a portion the respective belts 61, 65.

The belt 60 and microstructured belt 65 are driven by rotating cylinders 71-75, e.g., rollers or wheels indicated on FIG. 2 as circles with arrows showing the direction of rotation. The belts 60, 65 are endless belts, positioned in face to face relationship to each other for at least a portion of their lengths. The belts 60, 65 form, between their inside surfaces 40, 45, a mold cavity 80 for molding the polymeric sheet therebetween. Not shown, (but understood to be present by those of skill in the art) is a side wall on either side of the apparatus that bounds the mold cavity 80, preventing the monomer/polymer from extruding through the side of the mold cavity 80. In an embodiment, means are provided for affecting the spacing between the surfaces 40, 45 to affect the thickness of a polymeric sheet formed therebetween. This may be, for example, one or more adjustable belts 60, 65 that are adjustable in a vertical direction when the mold cavity 80 is in a horizontal plane. One or more of the belts 60, 65, may be mounted on a support that can move all the rollers associated with the belt or belts vertically at once.

A container 70 is in fluid communication with the mold cavity 80 and a reservoir 30. The container 70 is configured to introduce a liquid monomer or liquid polymer, initiator, and/or curing agent or to the mold cavity 80. Polymerization may take place in the mold cavity 80. In an embodiment, curing, such as by crosslinking, of the polymeric sheet takes place after the polymeric sheet is passed through the mold cavity.

A monomer fluid inlet 70, is configured to pour flowable monomer against a dam that is back wall of the reservoir 30 and thence into the mold cavity 80 defined by the spacing between the upper and lower belts 60, 65. The monomer 33 builds up in the dammed area which may be bounded by a dam or reservoir 30 and is evenly metered out into the gap between the belts 60, 65. The spacing between the belts 60, 65 determines the thickness of the final sheet produced, taking into account aspects such as shrinkage from the molten to solidified state of the thermoplastic polymer being formed. Generically indicated are cooling structures 80 and 82. These 80, 82 are in thermal communication with the mold cavity 80, and are configured for controllably cooling the melt/liquid polymer and solidifying the polymeric sheet as it moves through the mold cavity 80 to form the finished relatively rigid sheet 100. The belts 60, 65 also continuously remove the sheet from the mold cavity 80.

In an embodiment, as the monomer/polymer flows into the mold cavity 80 it will be molded with the microstructured optical surfaces of said tool area, such that when said polymer is cooled and solidified it forms a relatively rigid sheet having a microstructured optical quality surface that is the mirror image of the surface 40 of the tool area. In an embodiment, the mold cavity 80 lies in an approximately horizontal plane and at least the lower belt 65 includes the tool area (see 350 on FIG. 4).

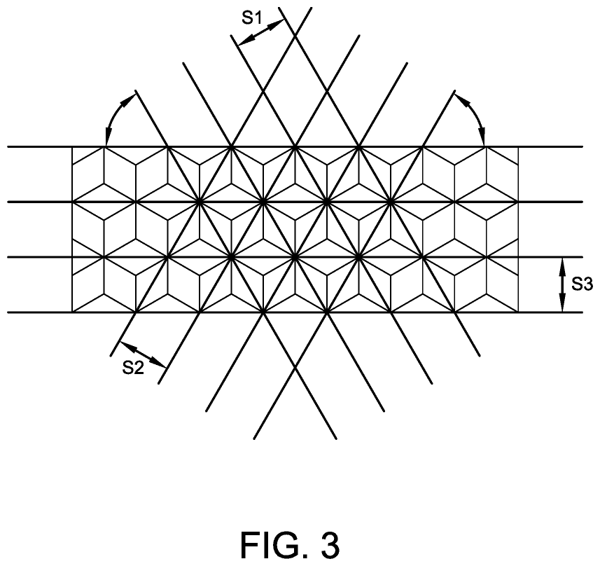

FIG. 3 depicts one version of the microstructured cube corner panel for making the ECE-104 conspicuity reflector design described in the Example below. A tool for making the cube corner array can be formed in a known manner via a diamond turning machine, wherein rows S1, S2 and S3 are cut into a substrate. Two angles are indicated on FIG. 3 with curved lines and arrows on each side. With the shrinkage factor of the polymer compensated for in the mold, these angles are 45 degrees+/−1, 3, or 5 degrees in the polymer. The present disclosure uses the array forming tool to form the optically precise microstructured belt 65 for use in a casting process, rather than the prior embossing tools. In the embodiment described herein, the microcubes are smaller than typically found for retroreflective highway sheeting. In this instance, the dimensions S1 and S2 were about 87 microns and S3 was about 81 microns. The nominal depth of the grooves was about 40 microns. For highway sheeting, the depth is about 120 microns and the distance of spacing is about 150 microns. In an embodiment, the dimensions S1, S2, and S3, mentioned above can be varied by, for example, a multiplier of 1% to 1000%, such as, 10% to 500%, or 50% to 200%.

In an embodiment, the panel is configured for an LED light cover. The light cover may of a size, rigidity, and configuration to replace traditional troffer light covers. For example, the light cover may be 2 feet by 4 feet, 2 feet by 2 feet, or 2 feet by 6 feet.

The material for the microstructured belt 65, may be a metal, such as stainless steel or nickel. The microstructures can be formed into the belt by diamond cutting, electroforming or some other process. The microstructured belt may, for example, have a thickness of 0.02 to 0.035 inches, such as 0.02 to 0.025 inches, or 0.025 to 0.03 inches.

In an embodiment for a road sign, the retroreflective pattern of cube corner elements 14 may be covered with a metallized layer, which, in turn, may be covered by a suitable backing material, in turn covered by a suitable adhesive (for mounting), in turn covered by release paper. The total thickness of the complete structure may be, for example, 0.005 to 0.05 inches, such as 0.008 to 0.02 inches, or 0.010 to 0.015 inches. In an embodiment, the structure is flexible enough so it can be rolled and readily stored on a supply reel.

In an embodiment for an LED light cover, the total thickness of the structure may be, for example, 1 mm to 20 mm, such as 2 to 10 mm, or 3 to 15 mm. In this embodiment, the final structure may be a monolayer acrylate panel with sufficient rigidity to retain its shape and not sag out of a traditional troffer light fixture.

FIG. 4 depicts an overhead view of a portion of a microstructured belt 365, modified in accordance with the present disclosure. In this case, certain regions of the belt 365 have been replaced with regions containing the microstructured tool area 350 configured to emboss the desired concomitant (mirror-image) structure on the finished panel. A plurality of alternating smooth areas 300 and microstructured tool areas 350 are provided on the belt 65 for continuously making both smooth and microstructured panels on the apparatus. Because horizontal casters may be as long as three hundred feet, making a full microstructured belt becomes extremely expensive, particularly as belts wear. By interspersing the microstructured tool areas 350 with the smooth areas 300 of a standard belt, it is possible to achieve high quality and efficient manufacture of the relatively rigid microstructured panels while also obtaining smooth panels as currently provided. For example, a smooth area 300 may comprise 50 to 99% of the total area of the belt, such as 65 to 95% or 80 to 90% with the remainder being microstructured tool areas 350. In this manner, a dual panel manufacturing process can be performed on a single apparatus. Both smooth, conventional sheets and microstructured sheets are cut and separated, and can be manufactured in one process.

In an embodiment, a process for making a relatively rigid polymeric panel having a microstructured surface on at least one area on said panel includes: casting a liquid monomeric or polymeric feed into a mold cavity, said cavity being defined by two continuously moving members spaced from one another. As explained above, the monomer/polymer may initially be cast onto a dam or reservoir 30. The microstructured tool area 350 on at least a portion of one of said moving members is passed over and against the monomer/polymer. In the mold cavity 80 the monomer is polymerized and the monomer/polymer is solidified as it is moved through said mold cavity 80 by converting to a solid polymer. After at least one surface of the polymer has a microstructured optical quality feature formed thereon, the solid polymeric panel is withdrawn from the mold cavity 80.

While a continuous caster process is the most efficient and economical, space considerations may encourage some companies to use smaller equipment in a “batch” process. In this instance, the mold cavity 401 of the mold 400 is defined by two plate-like spaced mold members 405, 410 (in this case top 405 and bottom 410 mold members). The bottom mold member 410 includes a perimeter seal 420 and a melt inlet 430. One of the mold members 405, 410 is provided with the microstructured tool surface 440 to replicate such surface on the polymer as it flows into the mold cavity 401. The spaced mold members 405, 410 are brought together to engage in an alignment to form the mold cavity therebetween and to press the monomer/polymer liquid into the mold members 405, 410, filling any defined recesses in the microstructured tool surface 440. Near to or included with the perimeter seal 420 is a lip that controls the gap between the mold members 405, 410 and the thickness of the panel. Polymerization of monomer occurs in the mold 400 and crosslinking may also occur. A controlled cooling apparatus, such as a water filled cooling bath 460 can be applied to the mold 400 to solidify the polymer to provide the relatively rigid microstructured panel. A cooling bath 460 can be used cool several molds 400 at a time. However, other cooling methods may also be used. The panel can then be removed from the mold 400 and the process repeated with the empty mold 400.

### Example

One example of the technology disclosed herein utilized a thin electroformed nickel mold that was approximately the same thickness as the stainless steel metal belts used on a PMMA caster machine to cast the same monomers on a lab scale operated by a major manufacturer of continuous cast PMMA. The precise optical pattern on the nickel mold used for this experiment was that of a known retroreflective product sold in the industry as ECE-104 conspicuity reflectors. The final 3 mm thick cast sheet compared favorably in precision and retroreflectivity to what would be typically produced by a continuous embossing process described previously, other than a minor change in dihedral angles which was due to the differential shrinkage in the polymer because of process variations.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially” as used herein means the specified materials or steps and those that do not materially affect the basic and novel characteristics of the material or method. All percentages and averages are by weight unless the context indicates otherwise. If not specified above, the properties mentioned herein may be determined by applicable ASTM standards, or if an ASTM standard does not exist for the property, the most commonly used standard known by those of skill in the art may be used. The articles “a,” “an,” and “the,” should be interpreted to mean “one or more” unless the context indicates the contrary.

1. A continuous casting apparatus for polymeric sheet comprising:
first and second endless belts, positioned in face to face relationship to each other for at least a portion of their lengths, forming between their inside surfaces a mold cavity for molding the polymeric sheet therebetween;
a container in fluid communication with the mold cavity, the container configured to introduce a liquid monomer and curing agent or liquid polymer to the mold cavity; and
a controlled cooling apparatus in thermal communication with the mold cavity, configured to cool and solidify the polymeric sheet as it moves through the mold cavity, wherein either the first, the second, or the first and second endless belts include a microstructured optical quality tool area on at least a portion of said belt or belts.

2. The continuous casting apparatus of claim 1, wherein as the liquid monomer or liquid polymer flows into said mold it will be molded with the microstructured optical quality tool area such that when said polymer is cooled and solidified it forms a relatively rigid sheet having a microstructured surface that is a mirror image of the microstructured optical quality tool area.

3. The continuous casting apparatus of claim 1, wherein said mold cavity lies in an approximately horizontal plane.

4. The continuous casting apparatus of claim 3, wherein the first belt is an upper belt and the second belt is a lower belt and the lower belt comprises the microstructured optical quality tool area.

5. A polymer casting apparatus for forming a relatively rigid polymer panel having a microstructured optical quality tool area on at least a portion of one side of said panel comprising:
two molding members positioned in face to face relationship to each other defining a mold cavity therebetween;
means for introducing a liquid monomer or polymer into said mold cavity; and
means for controlling cooling and solidifying said polymer in said mold cavity;
wherein at least one of said mold members has a tool area defining a microstructured surface which is filled by said liquid monomer or polymer, and when solidified the panel produced thereby has a microstructured optical quality surface that is a mirror image of said tool area.

6. The polymer casting apparatus of claim 5, further comprising means for affecting the spacing between said surfaces to affect the thickness of a polymer sheet formed therebetween.

7. The polymer casting apparatus of claim 5, further comprising controlled cooling means for effecting cooling and solidifying of the polymer as it moves through the mold cavity.

8. The polymer casting apparatus of claim 5, wherein the molding members are plates that are configured to engage in an alignment to form the mold cavity therebetween.

9. The polymer casting apparatus of claim 5, wherein the molding members are rotating belts configured to form a molding cavity between belt surfaces.

10. A process for making a relatively rigid polymeric panel having a microstructured surface on at least one area on said panel, the process comprising:
casting a liquid monomeric or polymeric feed into a mold cavity, said cavity being defined by two continuously moving members;
passing a microstructured tool area on at least a portion of one of said continuously moving members and polymerizing and solidifying the liquid monomeric or polymeric feed as it is moved through said mold cavity by converting the monomeric or polymeric feed to a solid polymer and withdrawing said solid polymer from said mold cavity whereby at least one surface of said polymer will have a microstructured optical quality feature formed thereon.

11. The process of claim 10, further comprising flowing monomer or polymer into a reservoir prior to casting it into a mold cavity.

12. The process of claim 10, further comprising polymerizing the monomer in the mold cavity.

13. The process of claim 10, wherein the liquid monomer or liquid polymer comprises an acrylate.

14. The process of claim 10, wherein the liquid monomer or liquid polymer is combined with an initiator or curing agent, or both.

15. The process of claim 10, wherein both members include a microstructured tool area that is passed over the monomeric or polymeric feed.

16. The process of claim 10, wherein at least one member comprises a plurality of alternating smooth areas and microstructured tool areas for continuously making both smooth and microstructured panels.

17. The continuous casting apparatus of claim 1, wherein a smooth area is 50 to 99% of the total area of the first or second belt, with the remainder being the microstructured tool area.

18. The process of claim 10, wherein the solid polymer is in the form of a panel:
and the panel has the microstructured surface formed thereon.

19. The process of claim 18, wherein the liquid monomer or liquid polymer comprises an acrylate.

20. The process of claim 18, wherein the panel is an LED light cover.
